(19) United States
(12) Patent Application Publication
(10) Pub. No.: US 2011/0268230 A1
(43) Pub. Date: Nov. 3, 2011

(54) OPTIMIZING A RECEIVER FOR MULTIPLE ANTENNA CONFIGURATIONS

(75) Inventors: Hao Xu, San Diego, CA (US); Robert Jason Fuchs, San Diego, CA (US); Ke Liu, San Diego, CA (US); James Corona, San Diego, CA (US); Zhifei Fan, San Diego, CA (US)

(73) Assignee: QUALCOMM INCORPORATED, San Diego, CA (US)

(21) Appl. No.: 12/916,114

(22) Filed: Oct. 29, 2010

Related U.S. Application Data
(60) Provisional application No. 61/328,834, filed on Apr. 28, 2010.

(51) Int. Cl. H04L 27/06

(52) U.S. Cl. 375/340

(57) ABSTRACT

A method for optimizing a multiple input multiple output (MIMO) receiver for multiple antenna configurations is disclosed. A noise covariance is determined based on a noise estimate of a wireless signal. A Cholesky decomposition matrix is determined based on the noise covariance. A whitening matrix is determined based on the Cholesky decomposition matrix. The wireless signal is whitened using the whitening matrix.

### RELATED APPLICATIONS

This application is related to and claims priority from U.S. Provisional Patent Application Ser. No. 61/328,834, entitled “Optimizing a Receiver for Multiple Antenna Configurations”, filed Apr. 28, 2010, and assigned to the assignee hereof and hereby expressly incorporated by reference herein.

### TECHNICAL FIELD

The present disclosure relates generally to communication systems. More specifically, the present disclosure relates to optimizing a receiver for multiple antenna configurations.

### BACKGROUND

Wireless communication systems have become an important means by which many people worldwide have come to communicate. A wireless communication system may provide communication for a number of mobile devices, each of which may be serviced by a base station. Examples of mobile devices include cellular phones, personal digital assistants (PDAs), handheld devices, wireless modems, laptop computers, personal computers, etc.

As wireless communication becomes more popular, different signal processing techniques may be used to increase the quality and efficiency of wireless devices. However, these techniques may depend on propagation environments and the configuration of other devices. Since other devices may have many different configurations, the signal processing techniques should be flexible in operation. Therefore, benefits may be realized by improved systems and methods for optimizing a receiver for multiple antenna configurations.

### SUMMARY

A method for optimizing a multiple input multiple output (MIMO) receiver for multiple antenna configurations is disclosed. A noise covariance is determined based on a noise estimate of a wireless signal. A Cholesky decomposition matrix is determined based on the noise covariance. A whitening matrix is determined based on the Cholesky decomposition matrix. The wireless signal is whitened using the whitening matrix.

The Cholesky decomposition matrix determination and the whitening matrix determination may reuse at least one function call more than once. The Cholesky decomposition matrix determination may use function calls A(a₀,a₁,a₂,a₃)=\sqrt{real(a₀)−(a₁²+a₂²+a₃²)},

$$B ( b ) = \frac{1}{b} ,$$

and C(c₀,c₁,c₂,c₃,c₄,c₅)=c₀(c₁−c₂c₃*−c₄c₅*) where a₀, a₁, a₂, and a₃ are constant values or elements in the noise covariance, b is the output of an A function call, and c₀, c₁, c₂, c₃, c₄, and c₅ are outputs from a B function call or constant values. The whitening matrix determination may use the function call D(d₀,d₁,d₂,d₃,d₄)=(d₀d₁−d₂d₃)d₄ where d₀, d₁, d₂, d₃, and d₁ are elements in the Cholesky decomposition matrix or intermediate values derived from elements in the Cholesky decomposition matrix. The stability of the whitening matrix determination may be controlled based on whether (real(a₀)−(a₁²+a₂²+a₃²)) is positive.

The whitening matrix determination may include recursively determining the whitening matrix based on a noise covariance matrix that is smaller than the whitening matrix. During the recursive algorithm, an upper left quadrant of the whitening matrix may be calculated based on an upper left quadrant of the noise covariance. An inverse of the upper left quadrant of the noise covariance may be calculated based on the upper left quadrant of the whitening matrix. A first intermediate 2×2 matrix may be calculated based on the inverse of the upper left quadrant of the noise covariance and a lower quadrant of the noise covariance. A second intermediate 2×2 matrix may be calculated based on a lower right quadrant of the noise covariance, the first intermediate 2×2 matrix and the lower left quadrant of the noise covariance. A lower right quadrant of the whitening matrix may be calculated based on the second intermediate 2×2 matrix. A lower left quadrant of the whitening matrix may be calculated based on the lower right quadrant of the whitening matrix and the first intermediate 2×2 matrix.

The receiver may be a multiple input multiple output (MIMO) receiver or a single input multiple output (SIMO) receiver. The receiver may have a different number of receive antennas than transmit antennas used to transmit the wireless signal. The whitened wireless signal may be estimated using Minimum Mean Square Error (MMSE). The estimated signal may be demodulated. The demodulated signal may be decoded. The receiver may be in a base station or a wireless communication device.

A wireless device for optimizing a receiver for multiple antenna configurations is also disclosed. The wireless device includes a processor and memory in electronic communication with the processor. Executable instructions are stored in the memory. The instructions are executable to determine a noise covariance based on a noise estimate of a wireless signal. The instructions are also executable to determine a Cholesky decomposition matrix based on the noise covariance. The instructions are also executable to determine a whitening matrix based on the Cholesky decomposition matrix. The instructions are also executable to whiten the wireless signal using the whitening matrix.

A wireless device for optimizing a receiver for multiple antenna configurations is also disclosed. The wireless device includes means for determining a noise covariance based on a noise estimate of a wireless signal. The wireless device also includes means for determining a Cholesky decomposition matrix based on the noise covariance. The wireless device also includes means for determining a whitening matrix based on the Cholesky decomposition matrix. The wireless device also includes means for whitening the wireless signal using the whitening matrix.

A computer-program product for optimizing a receiver for multiple antenna configurations is also disclosed. The computer-program product comprises a non-transitory computer-readable medium having instructions thereon. The instructions include code for causing a wireless device to determine a noise covariance based on a noise estimate of a wireless signal. The instructions also include code for causing the wireless device to determine a Cholesky decomposition matrix based on the noise covariance. The instructions also include code for causing the wireless device to determine a whitening matrix based on the Cholesky decomposition matrix. The instructions also include code for causing a wireless device to whiten the wireless signal using the whitening matrix.

### BRIEF DESCRIPTION OF THE DRAWINGS

FIG. 1 is a block diagram illustrating a wireless communication system with Multiple Input Multiple Output (MIMO) receivers that are optimized for multiple antenna configurations;

FIG. 2 is a block diagram illustrating a MIMO receiver in a wireless communication device or a base station;

FIG. 3 is a block diagram illustrating a MIMO receiver that is optimized for multiple antenna configurations;

FIG. 4 is a flow diagram illustrating a method for optimizing a receiver for multiple antenna configurations;

FIG. 5 illustrates means-plus-function blocks corresponding to the method of FIG. 4;

FIG. 6 is another flow diagram illustrating a method for optimizing a receiver for multiple configurations;

FIG. 7 illustrates means-plus-function blocks corresponding to the method of FIG. 6;

FIG. 8 is a block diagram illustrating a whitening matrix calculator;

FIG. 9 is another block diagram illustrating a whitening matrix calculator;

FIG. 10 is another block diagram illustrating a whitening matrix calculator;

FIG. 11 is a flow diagram illustrating a method of calculating a whitening matrix using a recursive approach;

FIG. 12 illustrates means-plus-function blocks corresponding to the method of FIG. 11; and

FIG. 13 illustrates certain components that may be included within a wireless device.

### DETAILED DESCRIPTION

For next generation wireless systems, antenna arrays may be deployed for both wireless communication devices and base stations. This may enable advanced transmission and reception techniques, such as Single User Multiple Input Multiple Output (SU-MIMO), Spatial Division Medium Access (SDMA), etc. In Long Term Evolution (LTE), for example, Multiple Input Multiple Output (MIMO) techniques may be considered for both uplink and downlink in Frequency Division Duplexing (FDD) systems and Time Division Duplexing (TDD) systems.

These signal processing techniques may involve beam forming or multiplexing of different transmission data streams. This may result in different antenna configurations. For example, in commercial Multiple Input Multiple Output (MIMO) systems, two antenna configurations are commonly used: pairs of cross-polarized antennas and closely spaced antenna arrays. The cross-polarized antenna arrays may be used to minimize antenna correlations. This may be common for systems with MIMO techniques or diversity techniques. The closely spaced linear antenna arrays may be used in systems with beam forming techniques. It may be common for TDD systems where channel reciprocity between uplink and downlink is exploited for beam forming.

The different configurations may result in different signal and noise correlations among antennas. For example, the correlation level may depend on antenna array geometry, antenna polarizations, propagation environments, and channel properties. An optimal receiver may be required to exploit the structure of the correlations. Therefore, the present systems and methods include a receiver for a wireless device that may accommodate multiple antenna configurations.

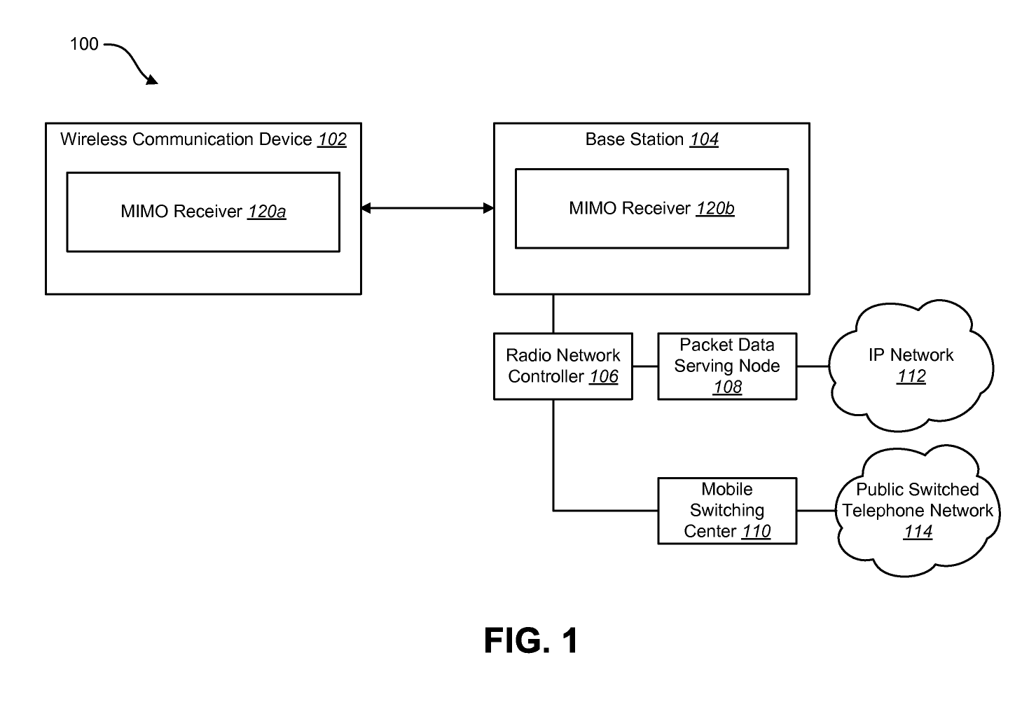

FIG. 1 is a block diagram illustrating a wireless communication system 100 with MIMO receivers 120 that are optimized for multiple antenna configurations. The system 100 may include a wireless communication device 102 that communicates with a base station 104. Examples of a wireless communication device 102 include cellular phones, personal digital assistants (PDAs), handheld devices, wireless modems, laptop computers, personal computers, etc. A wireless communication device 102 may alternatively be referred to as an access terminal, a mobile terminal, a mobile station, a remote station, a user terminal, a terminal, a subscriber unit, a mobile device, a wireless device, a subscriber station, user equipment, or some other similar terminology. The base station 104 may alternatively be referred to as an access point, a Node B, an evolved Node B, or some other similar terminology.

The base station 104 may communicate with a radio network controller 106 (also referred to as a base station controller or packet control function). The radio network controller 106 may communicate with a mobile switching center (MSC) 110, a packet data serving node (PDSN) 108 or internetworking function (IWF), a public switched telephone network (PSTN) 114 (typically a telephone company), and an Internet Protocol (IP) network 112 (typically the Internet). The mobile switching center 110 may be responsible for managing the communication between the wireless communication device 102 and the public switched telephone network 114 while the packet data serving node 108 may be responsible for routing packets between the wireless communication device 102 and the IP network 112.

The wireless communication device 102 may include a MIMO receiver 120a and/or the base station 104 may include a MIMO receiver 120b. The MIMO receivers 120 may receive signals and exploit the channel/noise correlations. In other words, the MIMO receivers 120 may process received signals (e.g., signals transmitted from a MIMO transmitter) to produce usable data for the wireless communication device 102 or base station 104. The general structure of the MIMO receiver 120 may include, without limitation, noise variance estimation, whitening filter calculation, channel and noise whitening, MIMO Minimum Mean Square Error (MMSE) receiver, demodulation, and decoding. This structure may accommodate multiple antenna configurations, e.g., cross-polarized antenna arrays and closely spaced antenna arrays. As used herein, the term “closely spaced” refers to antennas that are half of one wavelength of the operating frequency apart or less.

From communication theory point of view, a whitened MMSE receiver may be optimal for systems with both colored and white noise. However, there may be two design challenges. First, the complexity of general whitening filter calculation may cause inefficiencies. Second, stability of the whitening filter calculation from both fixed point design perspective and ill-conditioned matrix inversion perspective may be a problem. The MIMO receiver 120 may use a simple approach to calculate a whitening filter, e.g., Cholesky decomposition. Furthermore, the MIMO receiver 120 may include a rank dependent stability control. Alternatively, the MIMO receiver 120 may calculate a whitening filter using an iterative algorithm.

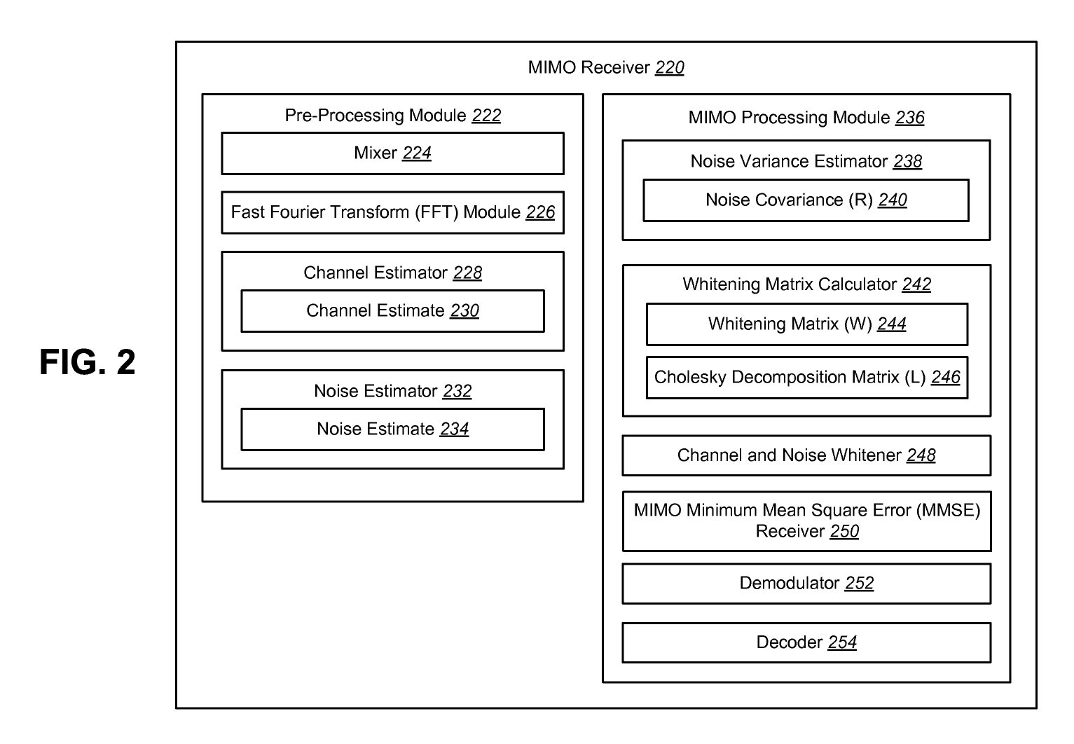

FIG. 2 is a block diagram illustrating a MIMO receiver 220 in a wireless communication device 102 or a base station 104. The MIMO receiver 220 may include a pre-processing module 222 and a MIMO processing module 236. The pre-processing module 222 may include a mixer 224 that down converts a radio frequency (RF) signal to a baseband signal and a Fast Fourier Transform (FFT) module 226 that transform the baseband signal into frequency domain representations of the baseband signal, e.g., pilot and non-pilot data. The pre-processing module 222 may also include a channel estimator 228 that determines a channel estimate 230 from a pilot signal and a noise estimator 232 that determines a noise estimate 234 by subtracting the channel estimate 230 from the pilot signal.

The MIMO processing module 236 may include a noise variance estimator 238 that determines a noise covariance matrix (R) 240 from the noise estimate 234. A whitening matrix calculator 242 may use one of two numerical techniques to determine a whitening matrix (W) 244, i.e., a Cholesky decomposition technique, using a Cholesky decomposition matrix (L) 246, or an iterative algorithm, both with functional reuse. Furthermore, a rank-based algorithm may be used by the whitening matrix calculator 242 to resolve stability issues. This may provide a general solution for a whitening matrix (W) 244 of any rank that may be efficiently implemented using the function calls described below. The whitening matrix (W) 244 may be used by a channel and noise whitener 248 to whiten the channel estimate 230 and noise estimate 234. A MIMO Minimum Mean Square Error (MMSE) receiver 250 may produce estimated data that may then be demodulated and decoded by a demodulator 252 and a decoder 254, respectively.

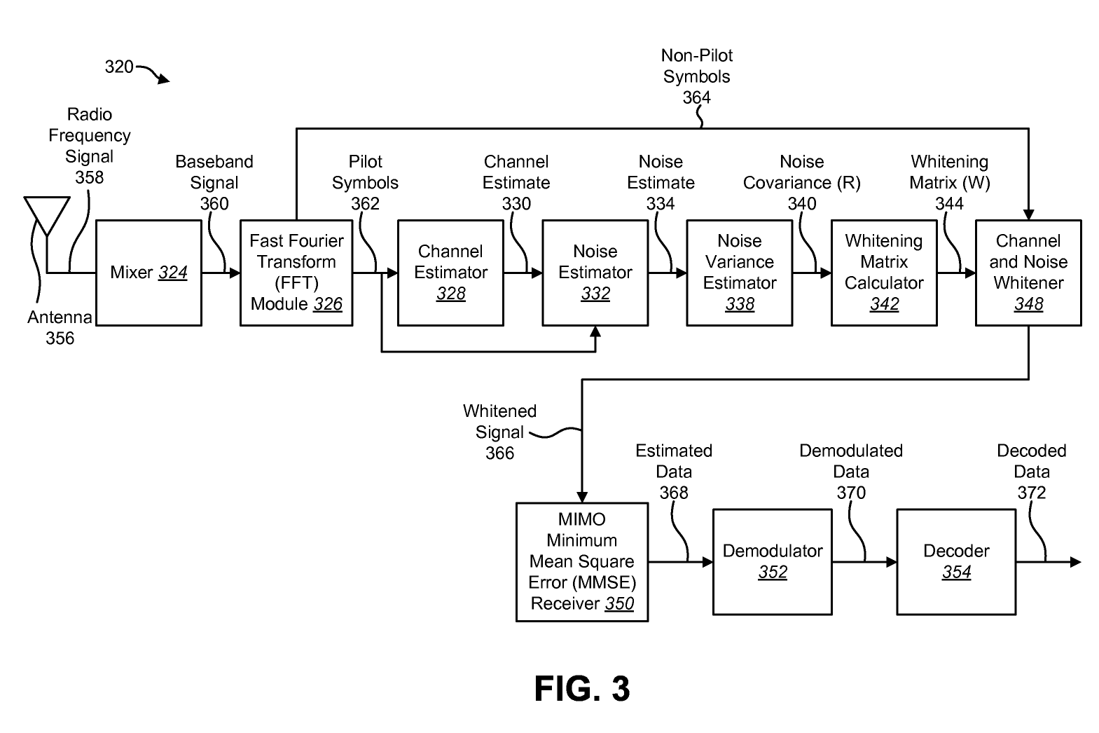

FIG. 3 is a block diagram illustrating a MIMO receiver 320 that is optimized for multiple antenna configurations. In other words, the MIMO receiver 320 may be in a wireless communication device 102 or a base station 104 that has a particular antenna configuration, e.g., cross-polarized antennas or closely spaced linear antennas. However, the MIMO receiver 320 may operate correctly for either of these configurations.

The MIMO receiver 320 may use various signal processing techniques to transform a received signal into usable data. First, one or more antennas 356 may wirelessly receive a radio frequency (RF) signal 358. A mixer 324 may convert the RF signal 358 into a baseband signal 360, i.e., convert from a higher transmission frequency to a lower frequency. The baseband signal 360 may be transformed into a frequency domain representation of pilot symbols 362 and non-pilot symbols 364 by a Fast Fourier Transform (FFT) module 326. The pilot symbols 362 may be used by a channel estimator 328 to determine a channel estimate 330. A noise estimator 332 may subtract the channel estimate 330 from the pilot symbols 362 to produce a noise estimate 334. A noise variance estimator 338 may determine a noise covariance (R) 340 from the noise estimate 334. A whitening matrix calculator 342 may determine a whitening matrix (W) 344 using a Cholesky decomposition matrix (L) 246. Alternatively, the whitening matrix calculator 342 may determine the whitening matrix (W) 344 using an iterative algorithm with functional reuse. The noise covariance (R) 340 may be in the form of Equation (1):

$$R = ( \begin{matrix}{ψ}_{00} & {ψ}_{01} & {ψ}_{02} & {ψ}_{03} \\ {ψ}_{10} & {ψ}_{11} & {ψ}_{12} & {ψ}_{13} \\ {ψ}_{20} & {ψ}_{21} & {ψ}_{22} & {ψ}_{23} \\ {ψ}_{30} & {ψ}_{31} & {ψ}_{32} & {ψ}_{33}\end{matrix} ) = {LL}^{H} \qquad ( 1 )$$

where R is the noise covariance 340, L is the Cholesky decomposition matrix 246, and L^{H} is the Hermitian transpose of the Cholesky decomposition matrix 246. The entries in the Cholesky decomposition matrix 246 may be referred to with the notation l_{xy} where x is the row number and y is the column number in of the entry in the Cholesky decomposition matrix (L) 246. For example, the entries in L 246 may be:

$${l}_{00} = \sqrt{{ψ}_{00}} ; {l}_{10} = {ψ}_{10} \frac{1}{{l}_{00}} ; {l}_{20} = {ψ}_{20} \frac{1}{{l}_{00}} ; {l}_{30} = {ψ}_{30} \frac{1}{{l}_{00}} ;$$

$${l}_{11} = \sqrt{{ψ}_{11} - {l}_{10}^{2}} ; {l}_{21} = \frac{1}{{l}_{11}} ( {ψ}_{21} - {l}_{20} {l}_{10}^{*} ) ; {l}_{31} = \frac{1}{{l}_{11}} ( {ψ}_{31} - {l}_{30} {l}_{30}^{*} ) ;$$

$${l}_{22} = \sqrt{{ψ}_{22} - {l}_{20}^{2} - {l}_{21}^{2}} ; {l}_{32} = \frac{1}{{l}_{22}} ( {ψ}_{32} - {l}_{30} {l}_{20}^{*} - {l}_{31} {l}_{21}^{*} ) ;$$

$${l}_{33} = \sqrt{{ψ}_{33} - ( {l}_{30}^{2} + {l}_{31}^{2} + {l}_{32}^{2} )}$$

The whitening matrix (W) 344 may be calculated as W=L⁻¹ according to Equation (2):

$$W = {L}^{- 1} = ( \begin{matrix}\frac{1}{{l}_{00}} & 0 & 0 & 0 \\ - \frac{{l}_{10}}{{l}_{00} {l}_{11}} & \frac{1}{{l}_{11}} & 0 & 0 \\ {l}_{sumi} ( {l}_{33} {l}_{21} {l}_{10} - {l}_{33} {l}_{20} {l}_{11} ) & - \frac{{l}_{21}}{{l}_{11} {l}_{22}} & \frac{1}{{l}_{22}} & 0 \\ {l}_{sumi} ( \begin{matrix}{l}_{11} {l}_{20} {l}_{32} - {l}_{11} {l}_{22} {l}_{30} + \\ {l}_{10} {l}_{22} {l}_{31} - {l}_{10} {l}_{21} {l}_{32}\end{matrix} ) & {l}_{sumi} ( \begin{matrix}{l}_{00} {l}_{21} {l}_{32} - \\ {l}_{00} {l}_{22} {l}_{31}\end{matrix} ) & - \frac{{l}_{32}}{{l}_{22} {l}_{33}} & \frac{1}{{l}_{33}}\end{matrix} ) \qquad ( 2 )$$

where lₛᵤₘᵢ refers to

$$\frac{1}{{l}_{00} {l}_{11} {l}_{22} {l}_{33 }} .$$

Using the whitening matrix (W) 344, a channel and noise whitener 348 may produce a whitened signal 366, after which a MIMO Minimum Mean Square Error (MMSE) receiver 350 may receive the whitened signal 366 and produce estimated data 368. The channel and noise whitener 348 and the MIMO MMSE receiver 350 may be combined into a whitened MMSE receiver (not shown). A demodulator 352 may produce demodulated data 370 and a decoder 354 may produce decoded data 372.

The whitening matrix calculator 342 may also implement rank dependent stability control of the whitening matrix (W) 344. As discussed below, the four diagonal terms of the whitening matrix (W) 344 may be calculated using the function call A(a₀,a₁,a₂,a₃)=\sqrt{real(a₀)−(a₁²+a₂²+a₃²)}=\sqrt{S} where a₀, a₁, a₂, and a₃ are input parameters that are constant values or elements of the noise covariance (R) 340. However, for ill conditioned 4×4 matrices, the term within the square root, S, may be either zero or negative due to the fixed point effect. Depending on the rank of the 4×4 noise covariance matrix (R) 340, this may happen for the second, third, or fourth diagonal element of the whitening matrix (W) 344.

To solve this problem, the whitening matrix calculator 342 may check the condition for stability for each calculation of A. In other words, if S is positive, then the full calculation may be performed and the system rank may be increased by one. In other words, when S is positive, A(a₀,a₁,a₂,a₃)=\sqrt{real(a₀)−(a₁²+a₂²+a₃²)}. Otherwise, if S is zero or negative, the whitening matrix calculator 342 may remove all negative terms and not increase the rank. Therefore, if S is zero or negative, A(a₀,a₁,a₂,a₃)=\sqrt{real(a₀)}. After all iterations are done, the terms may be zeroed out according to the system rank. Using this stability control, the form of the whitening matrix (W) 344 may depend on the rank of the noise covariance matrix (R) 340. When R 340 has a rank of 1, W 344 may be represented by Equation (3):

$$W = ( \begin{matrix}\frac{1}{{l}_{00}} & 0 & 0 & 0 \\ 0 & 0 & 0 & 0 \\ 0 & 0 & 0 & 0 \\ 0 & 0 & 0 & 0\end{matrix} ) \qquad ( 3 )$$

When R 340 has a rank of 2, W 344 may be represented by Equation (4):

$$W = ( \begin{matrix}\frac{1}{{l}_{00}} & 0 & 0 & 0 \\ - \frac{{l}_{10}}{{l}_{00} {l}_{11}} & \frac{1}{{l}_{11}} & 0 & 0 \\ 0 & 0 & 0 & 0 \\ 0 & 0 & 0 & 0\end{matrix} ) \qquad ( 4 )$$

When R 340 has a rank of 3, W 344 may be represented by Equation (5):

$$W = ( \begin{matrix}\frac{1}{{l}_{00}} & 0 & 0 & 0 \\ - \frac{{l}_{10}}{{l}_{00} {l}_{11}} & \frac{1}{{l}_{11}} & 0 & 0 \\ {l}_{sumi} ( {l}_{33} {l}_{21} {l}_{10} - {l}_{33} {l}_{20} {l}_{11} ) & - \frac{{l}_{21}}{{l}_{11} {l}_{22} } & \frac{1}{{l}_{22}} & 0 \\ 0 & 0 & 0 & 0\end{matrix} ) \qquad ( 5 )$$

When R 340 has a rank of 4, W 344 may be represented by Equation (6):

$$W = ( \begin{matrix}\frac{1}{{l}_{00}} & 0 & 0 & 0 \\ - \frac{{l}_{10}}{{l}_{00} {l}_{11}} & \frac{1}{{l}_{11}} & 0 & 0 \\ {l}_{sumi} ( {l}_{33} {l}_{21} {l}_{10} - {l}_{33} {l}_{20} {l}_{11} ) & - \frac{{l}_{21}}{{l}_{11} {l}_{22}} & \frac{1}{{l}_{22}} & 0 \\ {l}_{sumi} ( \begin{matrix}{l}_{11} {l}_{20} {l}_{32} - {l}_{11} {l}_{22} {l}_{30} + \\ {l}_{10} {l}_{21} {l}_{32} - {l}_{10} {l}_{21} {l}_{32}\end{matrix} ) & {l}_{sumi} ( \begin{matrix}{l}_{00} {l}_{21} {l}_{32} - \\ {l}_{00} {l}_{22} {l}_{31}\end{matrix} ) & - \frac{{l}_{32}}{{l}_{22} {l}_{33}} & \frac{1}{{l}_{33}}\end{matrix} ) \qquad ( 6 )$$

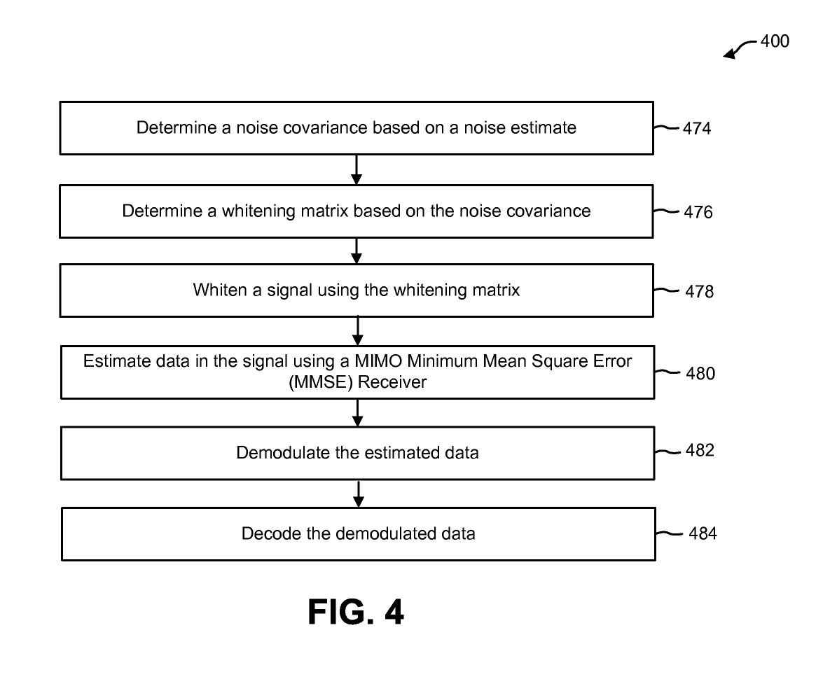

FIG. 4 is a flow diagram illustrating a method 400 for optimizing a receiver for multiple antenna configurations. The method 400 may be performed by a MIMO receiver 220 in a wireless communication device 102 or a base station 104. The MIMO receiver 220 may determine 474 a noise covariance (R) 240 based on a noise estimate 234. The noise estimate 234 may be estimated by subtracting a channel estimate 230 from pilot symbols 362. The MIMO receiver 220 may also determine 476 a whitening matrix (W) 244 based on the noise covariance (R) 240. This may include using Cholesky decomposition with functional reuse or an iterative algorithm with functional reuse. The MIMO receiver 220 may whiten 478 non-pilot symbols 364 using the whitening matrix (W) 244. As used herein, the term “whitening” refers to a decorrelation method that converts a covariance matrix, (e.g., the noise covariance 240), of a set of samples into the identity matrix, thus creating new random variables that are uncorrelated and have the same variances as the original random variables.

The MIMO receiver 220 may also estimate 480 data in the whitened signal 366 using a MIMO Minimum Mean Square Error (MMSE) receiver 250. The MIMO MMSE receiver 220 may provide an estimate 368 of the whitened signal 366 that minimizes the mean square error. The MIMO receiver 220 may also demodulate 482 the estimated data 368. Any suitable demodulation technique may be used and may correspond to the modulation method used to modulate the received signal, e.g., quadrature phase shift keying (QPSK), quadrature amplitude modulation (QAM), etc. The MIMO receiver 220 may decode 484 the demodulated data 370. Any suitable decoding technique may be used and may correspond to the encoding method used to encode the received signal, e.g., linear predictive coding (LPC).

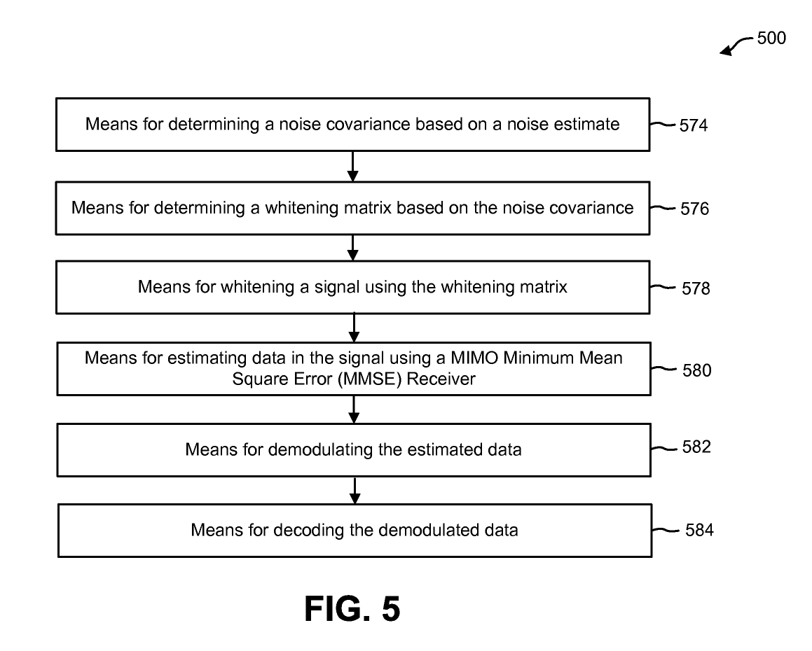

The method 400 of FIG. 4 described above may be performed by various hardware and/or software component(s) and/or module(s) corresponding to the means-plus-function blocks 500 illustrated in FIG. 5. In other words, blocks 474 through 484 illustrated in FIG. 4 correspond to means-plus-function blocks 574 through 584 illustrated in FIG. 5.

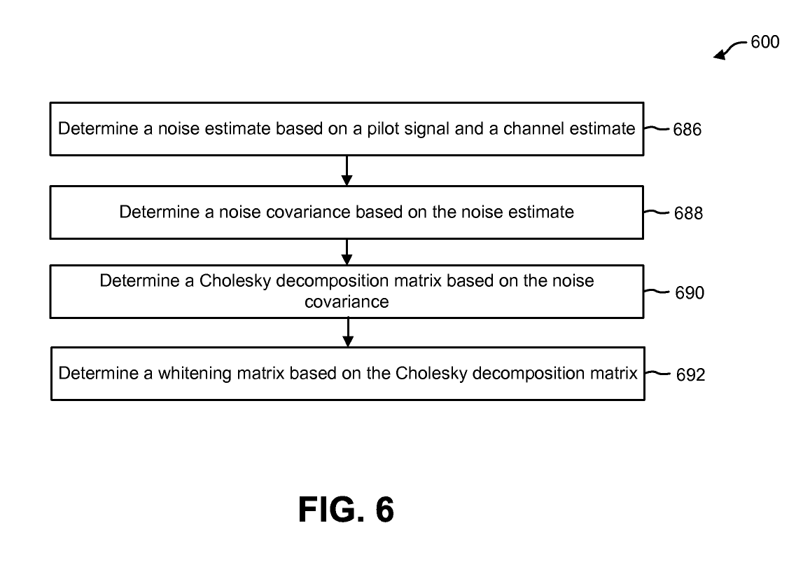

FIG. 6 is another flow diagram illustrating a method 600 for optimizing a receiver for multiple configurations. The method 600 may be performed by a MIMO receiver 220 in a wireless communication device 102 or a base station 104. Specifically, the method 600 may use a Cholesky decomposition technique. The MIMO receiver 220 may determine 686 a noise estimate 234 based on pilot symbols 362 and a channel estimate 230, e.g., the noise estimate 234 may be produced by subtracting the channel estimate 230 from the pilot signal. The MIMO receiver 220 may also determine 688 a noise covariance (R) 240 based on the noise estimate 234. The MIMO receiver 220 may also determine 690 a Cholesky decomposition matrix (L) 246 based on the noise covariance (R) 240. In other words, R=LL^{H}. Then, the MIMO receiver 692 may determine a whitening matrix (W) 244 based on the Cholesky decomposition matrix (W) 244, i.e., W=L⁻¹.

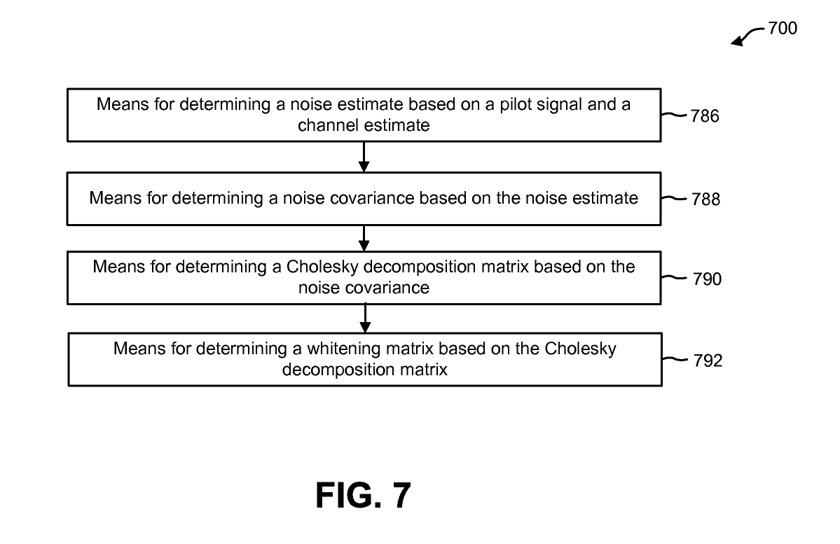

The method 600 of FIG. 6 described above may be performed by various hardware and/or software component(s) and/or module(s) corresponding to the means-plus-function blocks 700 illustrated in FIG. 7. In other words, blocks 686 through 692 illustrated in FIG. 6 correspond to means-plus-function blocks 786 through 792 illustrated in FIG. 7.

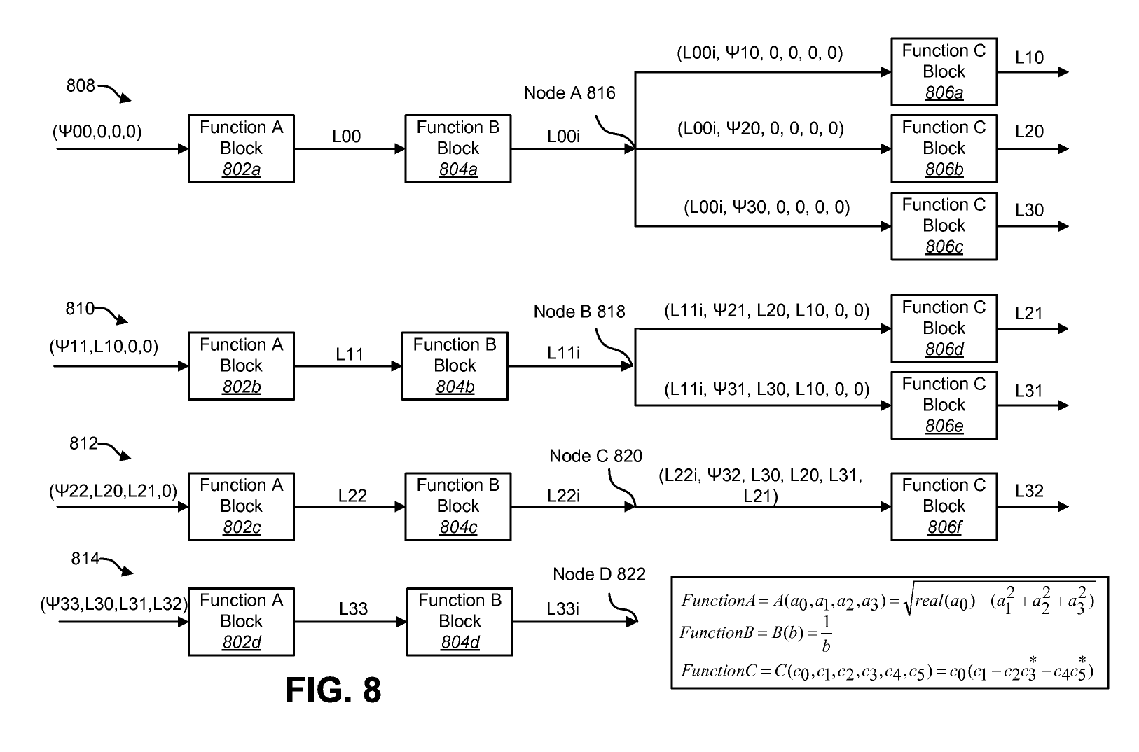

FIG. 8 is a block diagram illustrating a whitening matrix calculator 242. In other words, the block diagram illustrates the function calls used for the calculation of the Cholesky decomposition matrix (L) 246. Function A 802 may be defined according to Equation (7):

A(a₀,a₁,a₂,a₃)=\sqrt{real(a₀)−(a₁²+a₂²+a₃²)} (7)

Function B 804 may be defined according to Equation (8):

$$B ( b ) = \frac{1}{b} \qquad ( 8 )$$

Function C 806 may be defined according to Equation (9):

C(c₀,c₁,c₂,c₃,c₄,c₅)=c₀(c₁−c₂c₃*−c₄c₅*) (9)

In other words, function A 802, function B 804, and function C 806 may be used with various input parameters to produce outputs used to build the Cholesky decomposition matrix (L) 246. The input parameters may be elements of the noise covariance (R) 240, constant values, or previously computed elements of the Cholesky decomposition matrix (L) 246, e.g., a first computing chain 808 may produce l₁₀, l₂₀, and l₃₀ that may be used as inputs to the second computing chain 810, third computing chain 812, and/or fourth computing chain 814. For example, the first computing chain 808 may receive Ψ₀₀, 0, 0, and 0 as input to a function A block 802a, where Ψ₀₀ is the element in the 0^{th} row and 0^{th} column of the noise covariance matrix (R) 240. This may produce l₀₀ that may be used as input to a function B block 804a that produces l₀₀ᵢ where subscript i denotes inverse, i.e., l₀₀ᵢ=1/l₀₀. Various other input parameters may be added to l₀₀ᵢ as inputs to function C blocks 806a-c to produce l₁₀, l₂₀, and l₃₀. Thus, the first computing chain 808 may calculate l₀₀, l₁₀, l₂₀, and l₃₀ using a function A block 802a, a function B block 804a, and function C blocks 806a-c. Similarly, the second computing chain 810 may calculate l₁₁, l₂₁, and l₃₁ using a function A block 802b, a function B block 804b, and function C blocks 806d-e. Similarly, the third computing chain 812 may calculate l₂₂, and l₃₂ using a function A block 802c, a function B block 804c, and a function C block 806f. Similarly, the fourth computing chain 814 may calculate l₃₃ using a function A block 802d and a function B block 804d.

Each computing chain 808-814 may include a node that links to function blocks used for calculating the whitening matrix (W) 244 as described below. In other words, the first computing chain 808 may include node A 816, the second computing chain 810 may include node B 818, the third computing chain 812 may include node C 820, and the fourth computing chain 814 may include node D 822. As used herein, the term “computing chain” refers to any combination of hardware and software to implement logical operations. Any configuration of computing chains using the described function A blocks 802, function B blocks 804, or function C blocks 806 may be used. Alternatively, different function blocks may be used. Furthermore, the function blocks illustrated in FIGS. 8-10 may be reused. In other words, function A block 802a and function A block 802b may actually be the same set of hardware and/or software. Thus, the whitening matrix calculator 242 may use functional reuse to increase efficiency.

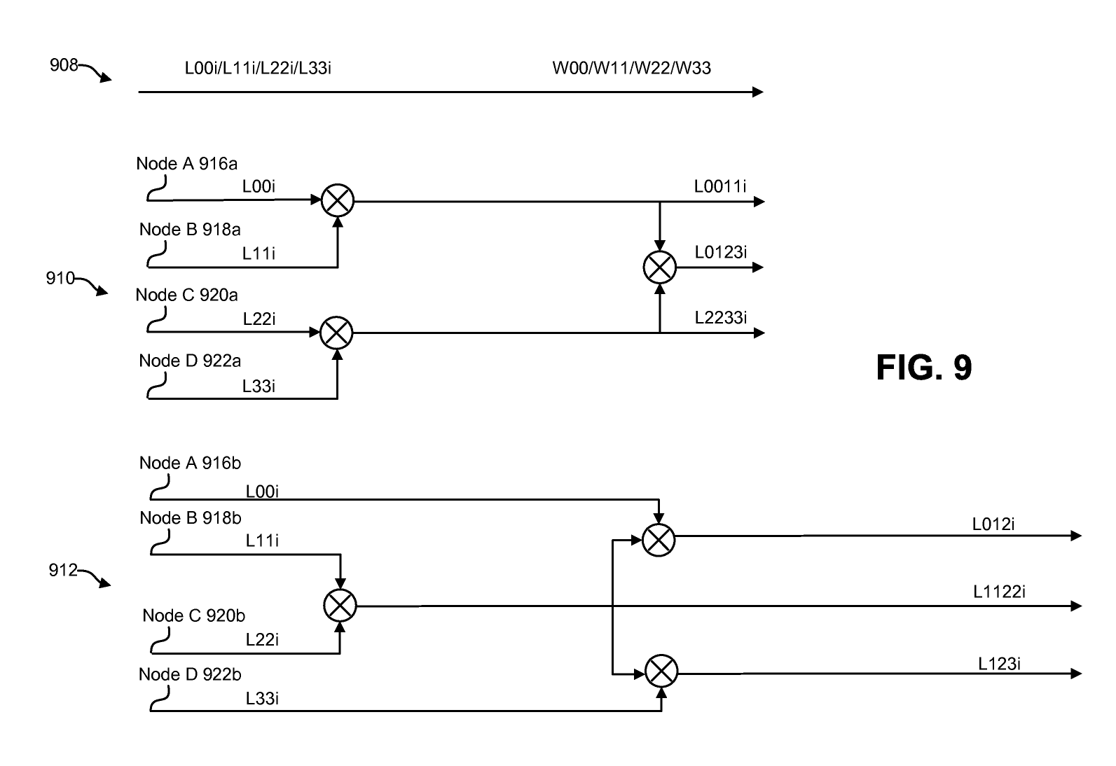

FIG. 9 is another block diagram illustrating a whitening matrix calculator 242. Specifically, FIG. 9 illustrates the calculation of elements in the whitening matrix (W) 244 and intermediate values used to calculate elements of the whitening matrix (W) 244. In other words, the illustrated computing chains may receive various input parameters to produce outputs used to build the whitening matrix (W) 244.

A first computing chain 908 may receive l₀₀ᵢ, l₁₁ᵢ, l₂₂ᵢ, and l₃₃ᵢ as inputs and produce w₀₀, w₁₁, w₂₂, and w₃₃ as outputs where w₀₀, w₁₁, w₂₂, and w₃₃ are elements in the whitening matrix (W) 244, e.g., by scaling the inputs. A second computing chain 910 may receive l₀₀ᵢ, l₁₁ᵢ, l₂₂ᵢ, and l₃₃ᵢ at node A 916a, node B 918a, node C 920a, and node D 922a, respectively, where node A 916a, node B 918a, node C 920a, and node D 922a correspond to node A 816, node B 818, node C 820, and node D 822 illustrated in FIG. 8. The second computing chain 910 may use multipliers to produce intermediate values that may be used later to calculate elements of the whitening matrix (W) 244. Likewise, a third computing chain 912 may use multipliers to produce intermediate values that may be used later to calculate elements of the whitening matrix (W) 244. Furthermore, node A 916b, node B 918b, node C 920b, and node D 922b also correspond to node A 816, node B 818, node C 820, and node D 822 illustrated in FIG. 8. Illustrated values with three or four digit numbering indicate intermediate the Cholesky decomposition matrix (L) 246, but are not themselves elements of the whitening matrix (W) 244 or the Cholesky decomposition matrix (L) 246.

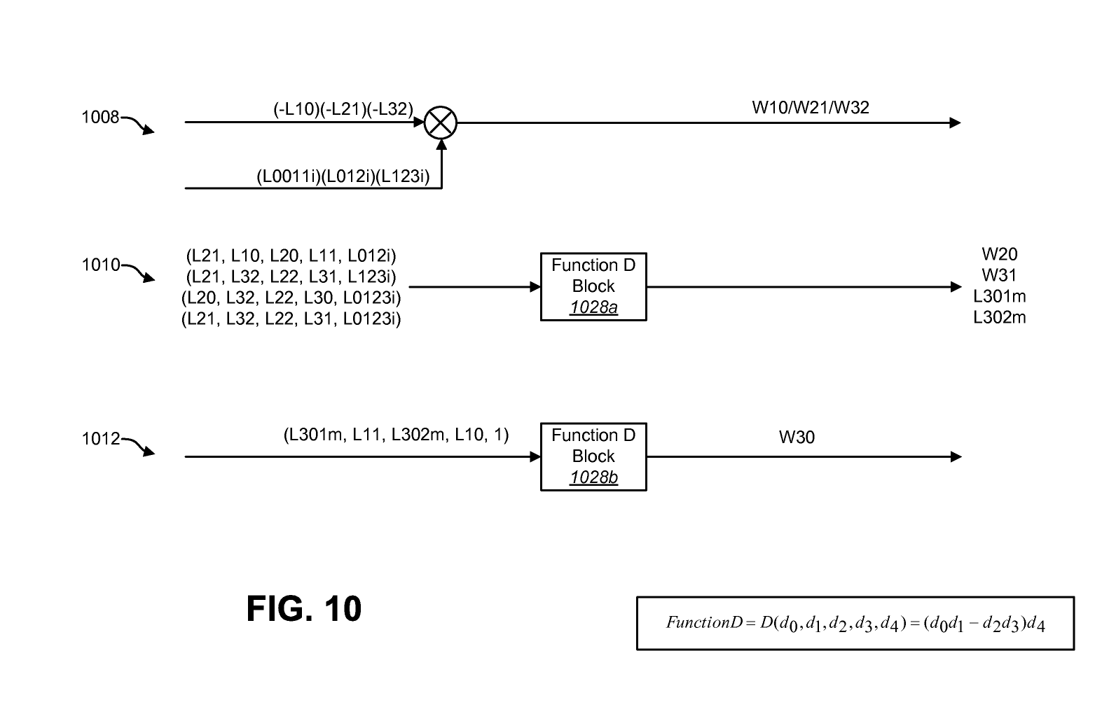

FIG. 10 is another block diagram illustrating a whitening matrix calculator 242. Specifically, FIG. 10 illustrates the calculation of elements in the whitening matrix (W) 244. Some of the calculations illustrated in FIG. 10 may utilize intermediate values, e.g., from FIG. 9.

A first computing chain 1008 may receive intermediate values and elements from the Cholesky decomposition matrix (L) 246 and use a multiplier to produce elements of the whitening matrix (W) 244, i.e., w₁₀, w₂₁, and w₃₂. For example, the first computing chain 1008 may multiply −l₃₃ᵢ with the intermediate value, l₀₁ᵢ produced by the second computing chain 910 illustrated in FIG. 9. A second computing chain 1010 may use a function D block 1028a to produce intermediate values and elements of the whitening matrix (W) 244. Function D 1028 may be defined according to Equation (10):

D(d₀,d₁,d₂,d₃,d₄)=(d₀d₁−d₂d₃)d₄ (10)

Similarly, a third computing chain 1012 may use a function D block 1028b to produce an element of the whitening matrix (W) 244, e.g., w₃₀.

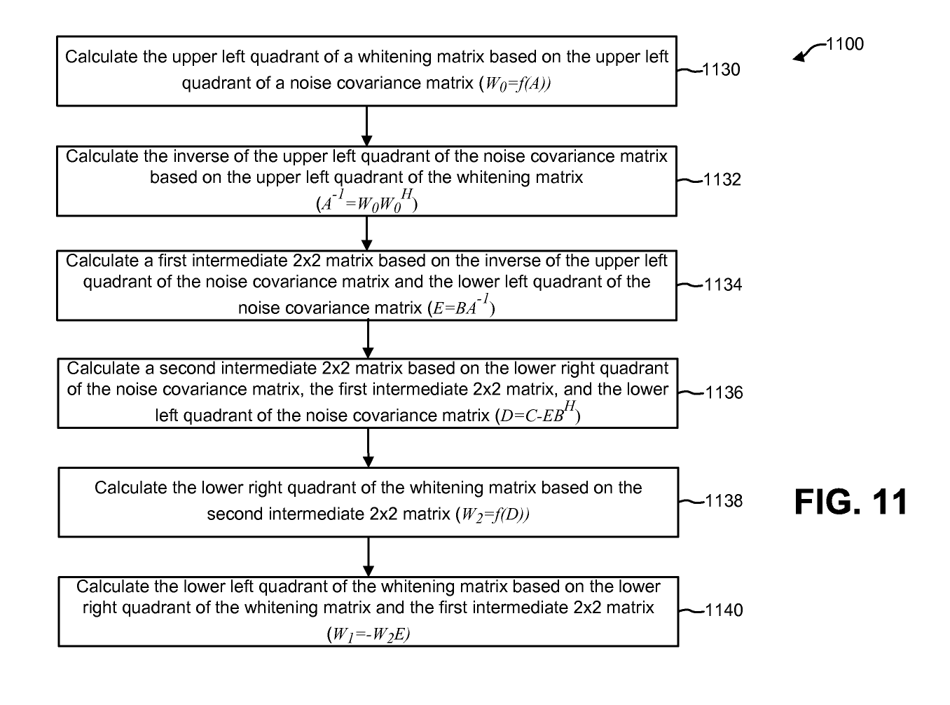

FIG. 11 is a flow diagram illustrating a method 1100 of calculating a whitening matrix (W) 244 using a recursive approach. The method 1100 may be performed by a whitening matrix calculator 242 in the MIMO receiver 120 of a wireless communication device 102 or a base station 104. In other words, the method 1100 may be an alternative approach to the Cholesky decomposition approach using function calls described above with respect to FIGS. 8-10. For purposes of illustration, assume that the noise covariance matrix (R) 240 takes the form in Equation (11):

$$Ψ = [ \begin{matrix}A & {B}^{′} \\ B & C\end{matrix} ] \qquad ( 11 )$$

and the desired whitening matrix (W) 244 should be in the form illustrated in Equation (12):

$$W = [ \begin{matrix}{W}_{0} & 0 \\ {W}_{1} & {W}_{2}\end{matrix} ] \qquad ( 12 )$$

Further assume for the notation Y=f(X), the function ƒ is a whitening function for a 2×2 matrix, i.e., Y is a 2×2 whitened matrix Y based on a 2×2 matrix X.

The whitening matrix calculator 242 may calculate 1130 the upper left quadrant of the whitening matrix (W) 244, W₀, based on the upper left quadrant of the noise covariance matrix (R) 240, A, i.e., W₀=f(A). The whitening matrix calculator 242 may also calculate 1132 the inverse of the upper left quadrant of the noise covariance matrix (R) 240, A⁻¹, based on W₀, i.e., A⁻¹=W₀W₀^{H}. The whitening matrix calculator 242 may also calculate 1134 a first intermediate 2×2 matrix, E, based on the inverse of the upper left quadrant of the noise covariance matrix (R) 240, A⁻, and the lower left quadrant of the noise covariance matrix (R) 240, B. In other words, E=BA⁻. The whitening matrix calculator 242 may also calculate 1136 a second intermediate 2×2 matrix, D, based on the lower right quadrant of the noise covariance matrix (R) 240, C, the first intermediate 2×2 matrix, E, and the lower left quadrant of the noise covariance matrix (R) 240, B. In other words, D=C−EB^{H}. The whitening matrix calculator 242 may also calculate 1138 the lower right quadrant of the whitening matrix (W) 244, W₂, based on the second intermediate 2×2 matrix, D, i.e., W₂=f(D). The whitening matrix calculator 242 may also calculate 1140 the lower left quadrant of the whitening matrix (W) 244, W₁, based on the lower right quadrant of the whitening matrix (W) 244, W₂, and the first intermediate 2×2 matrix, E. In other words, W₁=−W₂E.

Therefore, the recursive method 1100 may only be required to call a 2×2 whitening matrix engine twice to get the 4×4 whitening matrix (W) 244. Alternatively, a similar recursive method 1100 may be used to get an 8×8 whitening matrix (W) 244 from a 4×4 noise covariance matrix 240. Alternatively, any whitening matrix (W) 244 may be determined from a smaller noise covariance matrix 240 using a similar method 1100. Furthermore, a similar method 1100 may be used to obtain non-square whitening matrices (W) 244.

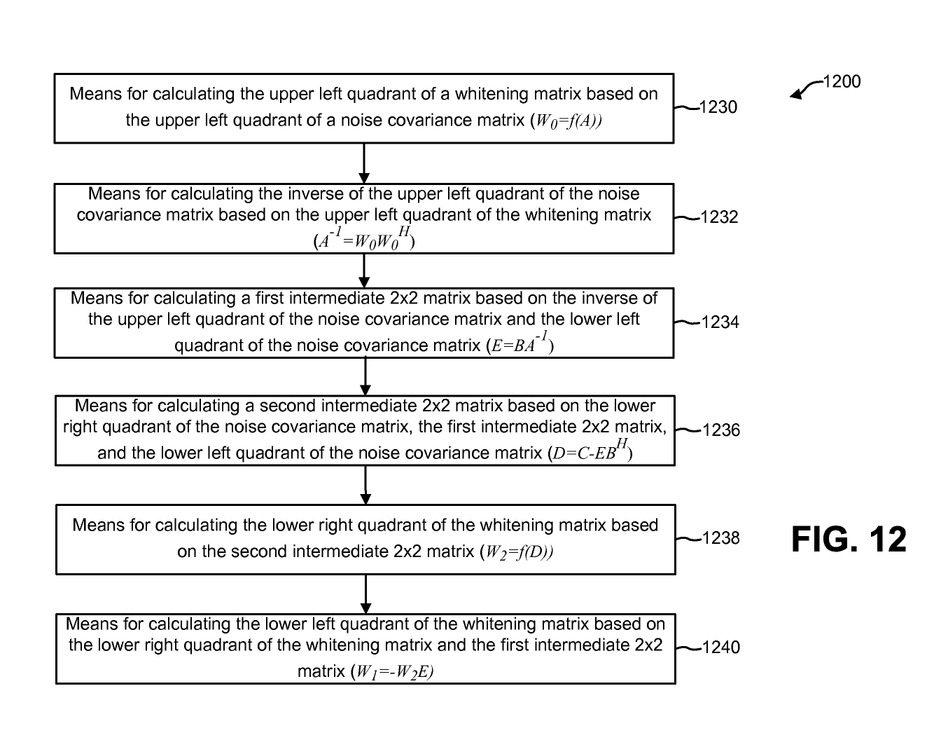

The method 1100 of FIG. 11 described above may be performed by various hardware and/or software component(s) and/or module(s) corresponding to the means-plus-function blocks 1200 illustrated in FIG. 12. In other words, blocks 1130 through 1140 illustrated in FIG. 11 correspond to means-plus-function blocks 1230 through 1240 illustrated in FIG. 12.

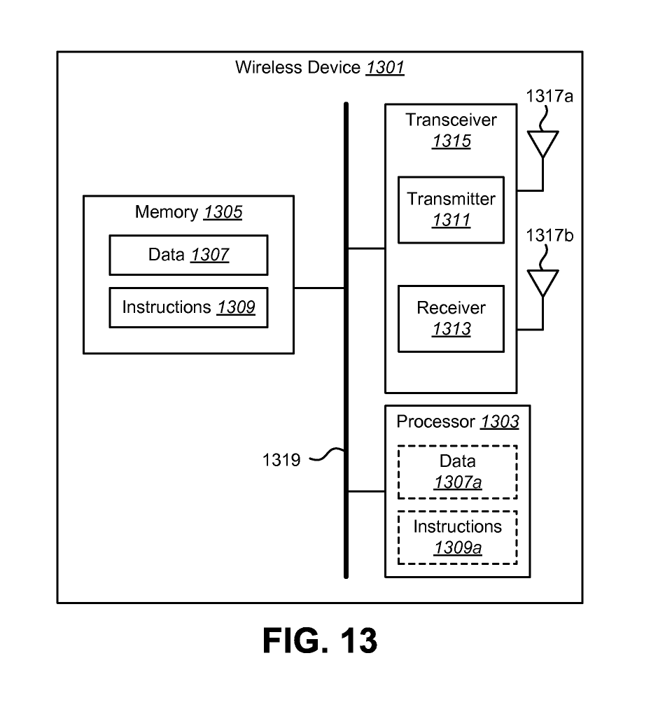

FIG. 13 illustrates certain components that may be included within a wireless device 1301. The wireless device 1301 may be a wireless communication device 102 or a base station 104.

The wireless device 1301 includes a processor 1303. The processor 1303 may be a general purpose single- or multi-chip microprocessor (e.g., an ARM), a special purpose microprocessor (e.g., a digital signal processor (DSP)), a microcontroller, a programmable gate array, etc. The processor 1303 may be referred to as a central processing unit (CPU). Although just a single processor 1303 is shown in the wireless device 1301 of FIG. 13, in an alternative configuration, a combination of processors (e.g., an ARM and DSP) could be used.

The wireless device 1301 also includes memory 1305. The memory 1305 may be any electronic component capable of storing electronic information. The memory 1305 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1307 and instructions 1309 may be stored in the memory 1305. The instructions 1309 may be executable by the processor 1303 to implement the methods disclosed herein. Executing the instructions 1309 may involve the use of the data 1307 that is stored in the memory 1305. When the processor 1303 executes the instructions 1307, various portions of the instructions 1309a may be loaded onto the processor 1303, and various pieces of data 1307a may be loaded onto the processor 1303.

The wireless device 1301 may also include a transmitter 1311 and a receiver 1313 to allow transmission and reception of signals between the wireless device 1301 and a remote location. The transmitter 1311 and receiver 1313 may be collectively referred to as a transceiver 1315. An antenna 1317 may be electrically coupled to the transceiver 1315. The wireless device 1301 may also include (not shown) multiple transmitters, multiple receivers, multiple transceivers and/or multiple antenna.

The various components of the wireless device 1301 may be coupled together by one or more buses, which may include a power bus, a control signal bus, a status signal bus, a data bus, etc. For the sake of clarity, the various buses are illustrated in FIG. 13 as a bus system 1319.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be stored as one or more instructions on a computer-readable medium. The terms “computer-readable medium” or “computer-program product” refer to any available medium that can be accessed by a computer or computing device. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray° disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4, 6, and 11, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for optimizing a receiver for multiple antenna configurations, comprising:
determining a noise covariance based on a noise estimate of a wireless signal;
determining a Cholesky decomposition matrix based on the noise covariance;
determining a whitening matrix based on the Cholesky decomposition matrix; and
whitening the wireless signal using the whitening matrix.

2. The method of claim 1, wherein the determining the Cholesky decomposition matrix and the determining the whitening matrix comprises reusing at least one function call more than once.

3. The method of claim 1, wherein the determining the Cholesky decomposition matrix uses function calls A(a₀,a₁,a₂,a₃)=\sqrt{real(a₀)−(a₁²+a₂²+a₃²)},
$$B ( b ) = \frac{1}{b} ,$$
and C(c₀,c₁,c₂,c₃,c₄,c₅)=c₀(c₁−c₂c₃*−c₄c₅), wherein a₀, a₁, a₂, and a₃ are constant values or elements in the noise covariance, b is the output of an A function call, and c₀, c₁, c₂, c₃, c₄, and c₅ are outputs from a B function call or constant values.

4. The method of claim 1, wherein the determining the whitening matrix uses function call D(d₀,d₁,d₂,d₃,d₄)=(d₀d₁−d₂d₃)d₄ where d₀, d₁, d₂, d₃, and d₁ are elements in the Cholesky decomposition matrix or intermediate values derived from elements in the Cholesky decomposition matrix.

5. The method of claim 3, further comprising controlling stability of the whitening matrix determination based on whether (real (a₀)−(a₁²+a₂²+a₃²)) is positive.

6. The method of claim 1, wherein the determining the whitening matrix comprises recursively determining the whitening matrix based on a noise covariance matrix that is smaller than the whitening matrix.

7. The method of claim 1, wherein the determining the whitening matrix uses a recursive algorithm comprising:
calculating an upper left quadrant of the whitening matrix based on an upper left quadrant of the noise covariance;
calculating an inverse of the upper left quadrant of the noise covariance based on the upper left quadrant of the whitening matrix;
calculating a first intermediate 2×2 matrix based on the inverse of the upper left quadrant of the noise covariance and a lower quadrant of the noise covariance;
calculating a second intermediate 2×2 matrix based on a lower right quadrant of the noise covariance, the first intermediate 2×2 matrix, and the lower left quadrant of the noise covariance;
calculating a lower right quadrant of the whitening matrix based on the second intermediate 2×2 matrix; and
calculating a lower left quadrant of the whitening matrix based on the lower right quadrant of the whitening matrix and the first intermediate 2×2 matrix.

8. The method of claim 1, wherein the receiver is a multiple input multiple output (MIMO) receiver or a single input multiple output (SIMO) receiver.

9. The method of claim 1, wherein the receiver has a different number of receive antennas than transmit antennas used to transmit the wireless signal.

10. The method of claim 1, further comprising:
estimating the whitened wireless signal using Minimum Mean Square Error (MMSE);
demodulating the estimated signal; and
decoding the demodulated signal.

11. The method of claim 1, wherein the receiver is in a base station.

12. The method of claim 1, wherein the receiver is in a wireless communication system.

13. A wireless device for optimizing a receiver for multiple antenna configurations, comprising:
a processor;
memory in electronic communication with the processor;
instructions stored in the memory, the instructions being executable by the processor to:
determine a noise covariance based on a noise estimate of a wireless signal;
determine a Cholesky decomposition matrix based on the noise covariance;
determine a whitening matrix based on the Cholesky decomposition matrix; and
whiten the wireless signal using the whitening matrix.

14. The wireless device of claim 13, wherein the instructions executable to determine the Cholesky decomposition matrix and determine the whitening matrix comprise instructions executable to reuse at least one function call more than once.

15. The wireless device of claim 13, wherein the instructions executable to determine the Cholesky decomposition matrix use function calls A(a₀,a₁,a₂,a₃)=\sqrt{real(a₀)−(a₁²+a₂²+a₃²)},
$$B ( b ) = \frac{1}{b} ,$$
and C(c₀,c₁,c₂,c₃,c₄,c₅)=c₀(c₁−c₂c₃*−c₄c₅*), wherein a₀, a₁, a₂, and a₃ are constant values or elements in the noise covariance, b is the output of an A function call, and c₀, c₁, c₂, c₃, c₄, and c₅ are outputs from a B function call or constant values.

16. The wireless device of claim 13, wherein the instructions executable to determine the whitening matrix use a function call D(d₀,d₁,d₂,d₃,d₄)=(d₀d₁−d₂d₃)d₄ where d₀, d₁, d₂, d₃, and d₄ are elements in the Cholesky decomposition matrix or intermediate values derived from elements in the Cholesky decomposition matrix.

17. The wireless device of claim 16, further comprising instructions executable to control stability of the whitening matrix determination based on whether (real(a₀)−(a₁²+a₂²+a₃²)) is positive.

18. The wireless device of claim 13, wherein the instructions executable to determine the whitening matrix comprise instructions executable to recursively determine the whitening matrix based on a noise covariance matrix that is smaller than the whitening matrix.

19. The wireless device of claim 13, wherein the instructions executable to determine the whitening matrix use a recursive algorithm comprising instructions executable to:
calculate an upper left quadrant of the whitening matrix based on an upper left quadrant of the noise covariance;
calculate an inverse of the upper left quadrant of the noise covariance based on the upper left quadrant of the whitening matrix;
calculate a first intermediate 2×2 matrix based on the inverse of the upper left quadrant of the noise covariance and a lower quadrant of the noise covariance;
calculate a second intermediate 2×2 matrix based on a lower right quadrant of the noise covariance, the first intermediate 2×2 matrix, and the lower left quadrant of the noise covariance;
calculate a lower right quadrant of the whitening matrix based on the second intermediate 2×2 matrix; and
calculate a lower left quadrant of the whitening matrix based on the lower right quadrant of the whitening matrix and the first intermediate 2×2 matrix.

20. The wireless device of claim 13, wherein the receiver is a multiple input multiple output (MIMO) receiver or a single input multiple output (SIMO) receiver.

21. The wireless device of claim 13, wherein the receiver has a different number of receive antennas than transmit antennas used to transmit the wireless signal.

22. The wireless device of claim 13, further instructions executable to:
estimate the whitened wireless signal using Minimum Mean Square Error (MMSE);
demodulate the estimated signal; and
decode the demodulated signal.

23. The wireless device of claim 13, wherein the wireless device is a base station.

24. The wireless device of claim 13, wherein the wireless device is a wireless communication device.

25. A wireless device for optimizing a receiver for multiple antenna configurations, comprising:
means for determining a noise covariance based on a noise estimate of a wireless signal;
means for determining a Cholesky decomposition matrix based on the noise covariance;
means for determining a whitening matrix based on the Cholesky decomposition matrix; and
means for whitening the wireless signal using the whitening matrix.

26. The wireless device of claim 25, wherein the means for determining the Cholesky decomposition matrix and the means for determining the whitening matrix reuse at least one function call more than once.

27. The wireless device of claim 25, wherein the means for determining the Cholesky decomposition matrix uses function calls A(a₀,a₁,a₂,a₃)=\sqrt{real(a₀)−(a₁²+a₂²+a₃²)},
$$B ( b ) = \frac{1}{b} ,$$
and C(c₀,c₁,c₂,c₃,c₄,c₅)=c₀(c₁−c₂c₃*−c₄c₅*), wherein a₀, a₁, a₂, and a₃ are constant values or elements in the noise covariance, b is the output of an A function call, and c₀, c₁, c₂, c₃, c₄, and c₅ are outputs from a B function call or constant values.

28. The wireless device of claim 25, wherein the means for determining the whitening matrix uses function call D(d₀,d₁,d₂,d₃,d₄)=(d₀d₁−d₂d₃)d₄ where d₀, d₁, d₂, d₃, and d₄ are elements in the Cholesky decomposition matrix or intermediate values derived from elements in the Cholesky decomposition matrix.

29. The wireless device of claim 28, further comprising means for controlling stability of the whitening matrix determination based on whether (real(a₀)−(a₁²+a₂²+a₃²)) is positive.

30. The wireless device of claim 25, wherein the means for determining the whitening matrix comprise means for recursively determining the whitening matrix based on a noise covariance matrix that is smaller than the whitening matrix.

31. The wireless device of claim 25, wherein the means for determining the whitening matrix uses a recursive algorithm comprising:
means for calculating an upper left quadrant of the whitening matrix based on an upper left quadrant of the noise covariance;
means for calculating an inverse of the upper left quadrant of the noise covariance based on the upper left quadrant of the whitening matrix;
means for calculating a first intermediate 2×2 matrix based on the inverse of the upper left quadrant of the noise covariance and a lower quadrant of the noise covariance;
means for calculating a second intermediate 2×2 matrix based on a lower right quadrant of the noise covariance, the first intermediate 2×2 matrix, and the lower left quadrant of the noise covariance;
means for calculating a lower right quadrant of the whitening matrix based on the second intermediate 2×2 matrix; and
means for calculating a lower left quadrant of the whitening matrix based on the lower right quadrant of the whitening matrix and the first intermediate 2×2 matrix.

32. A computer-program product for optimizing a receiver for multiple antenna configurations, the computer-program product comprising a non-transitory computer-readable medium having instructions thereon, the instructions comprising:
code for causing a wireless device to determine a noise covariance based on a noise estimate of a wireless signal;
code for causing the wireless device to determine a Cholesky decomposition matrix based on the noise covariance;
code for causing the wireless device to determine a whitening matrix based on the Cholesky decomposition matrix; and
code for causing a wireless device to whiten the wireless signal using the whitening matrix.

33. The computer-program product of claim 1, wherein the determining the code for determining the Cholesky decomposition matrix and the code for determining the whitening matrix reuse at least one function call more than once.

34. The computer-program product of claim 32, wherein the code for determining the Cholesky decomposition matrix uses function calls A(a₀,a₁,a₂,a₃)=\sqrt{real(a₀)−(a₁²+a₂²+a₃²)},
$$B ( b ) = \frac{1}{b} ,$$
and C(c₀, c₁,c₂,c₃,c₄,c₅)=c₀(c₁−c₂c₃*−c₄c₅*), wherein a₀, a₁, a₂, and a₃ are constant values or elements in the noise covariance, b is the output of an A function call, and c₀, c₁, c₂, c₃, c₄, and c₅ are outputs from a B function call or constant values.

35. The computer-program product of claim 32, wherein the code for determining the whitening matrix uses function call D(d₀,d₁,d₂,d₃,d₄)=(d₀d₁−d₂d₃)d₄ where d₀, d₁, d₂, d₃, and d₄ are elements in the Cholesky decomposition matrix or intermediate values derived from elements in the Cholesky decomposition matrix.

36. The computer-program product of claim 35, further comprising code for controlling stability of the whitening matrix determination based on whether (real(a₀)−(a₁²+a₂²+a₃²)) is positive.

37. The computer-program product of claim 32, wherein the determining the whitening matrix comprises recursively determining the whitening matrix based on a noise covariance matrix that is smaller than the whitening matrix.

38. The computer-program product of claim 32, wherein the code for determining the whitening matrix uses a recursive algorithm comprising:
code for calculating an upper left quadrant of the whitening matrix based on an upper left quadrant of the noise covariance;
code for calculating an inverse of the upper left quadrant of the noise covariance based on the upper left quadrant of the whitening matrix;
code for calculating a first intermediate 2×2 matrix based on the inverse of the upper left quadrant of the noise covariance and a lower quadrant of the noise covariance;
code for calculating a second intermediate 2×2 matrix based on a lower right quadrant of the noise covariance, the first intermediate 2×2 matrix, and the lower left quadrant of the noise covariance;
code for calculating a lower right quadrant of the whitening matrix based on the second intermediate 2×2 matrix; and
code for calculating a lower left quadrant of the whitening matrix based on the lower right quadrant of the whitening matrix and the first intermediate 2×2 matrix.
